(19) United States
(12) Patent Application Publication
(10) Pub. No.: US 2020/0083763 A1
(43) Pub. Date: Mar. 12, 2020

(54) HUMAN-LIKE DIRECT DRIVE ROBOT

(71) Applicant: HALODI ROBOTICS A/S, Moss (NO)

(72) Inventors: Phuong NGUYEN, Moss (NO); Bernt Øivind BØRNICH, Moss (NO)

(21) Appl. No.: 16/485,635

(22) PCT Filed: Feb. 16, 2017
(86) PCT No.: PCT/EP2017/053538

§ 371 Date: Aug. 13, 2019

(51) Int. Cl. H02K 1/14; H02K 1/27; H02K 7/08; B25J 17/02; B25J 19/00; B25J 9/00; B25J 9/08; B25J 9/10; B25J 9/06; B25J 9/16

(52) U.S. Cl. CPC H02K 1/146; H02K 2213/03; H02K 7/08; B25J 17/0283; B25J 19/0029; B25J 9/0006; B25J 9/0027; B25J 9/08; B25J 9/103; B25J 9/06; B25J 9/1045; B25J 9/108; B25J 9/106; B25J 9/1633; B25J 9/1641; B25J 9/1682; H02K 1/2786

(57) ABSTRACT

The present disclosure relates to a motor, in particular a compact, lightweight and high torque motor. The rotor comprises a Halbach array magnet structure in which the projected magnetic field is directed toward the rotation axis of the motor and the stator comprises a plurality of poles within the Halbach array. The individual magnets making up the Halbach array have a thickness in the radial direction, with respect to the rotation axis, which is determined to be the minimum thickness required to stop demagnetisation of the magnets when the maximum current to generate peak torque output of the motor is driven through the stator at the maximum expected temperature at which the motor will be used.

### BACKGROUND TO THE INVENTION

Robots have been the stuff of science fiction novels for decades, with a common plot including a robot able to mimic human behaviour and provide an assistant for the home, office or industry. As is often the case, however, reality in the field of robotics and robots in general, differs from the imagination of science fiction authors. It is undeniable that the field of robotics has advanced enormously, and in many industrial settings it is common to find fully automated systems performing tasks with high precision and high speed. Many of today's robots are designed with a limited range of tasks in mind, and are specialists in particular fields of automation of industry. The field of robotics and robot design for replacing humans in a wide variety of tasks, by contrast, has not developed at such a pace and it seems that to date a realistic robot for the home is still very much the stuff of science fiction novels!

One of the issues regarding robotics design for the environment in which humans also coexist, is the significant safety issues and dangers which robots pose. In particular, robots performing a pre-programmed series of tasks will readily be able to repeat said task as long as nothing unexpected comes between the task and the motion of the robot. One can imagine a robot programmed to move items from one conveyor to another in a factory, wherein the robot is programmed to remove one item from one conveyor belt and place this on a separate conveyor belt. Such robots operate in a completely known and controlled environment, and consequently it is not necessary to provide for unexpected eventualities interfering with the motion and tasks of the robot. One may also imagine, however, the unfortunate situation of a human being in the working environment of such a robot, wherein the robot would continue to perform the scheduled duties and could do significant harm to a human who inadvertently gets in the path of the robot's movement. Indeed, many robots have the very real possibility of inflicting significant harm to humans who come into their vicinity and stand within a programmed movement path, as such robots are neither designed nor programmed to adjust to an unexpected environment or person within such an environment.

The field of robotics which is intended to interact with a non-standard environment, clearly requires that the robot is provided with numerous sensors which are able to detect any unexpected or different objects and people within the vicinity of the robot, thus allowing appropriate action to be taken to avoid causing a human any harm. One can readily imagine a robot being provided with a series of proximity sensors or optical systems, such that the robot would be able to actively monitor its environment and when performing a desired task take appropriate care to avoid causing harm to anyone or anything in the robot's environment. For true interaction between humans and human-like robots, however, it is desirable for the robot to not only be able to perform tasks in a similar manner to that of the human, but also respond to the changing environment in a similar manner. It is additionally desirable that actual physical interaction between humans and human-like robots comes as close to that which the human would expect when interacting with another human, and not least this relates to actually physically interacting with the robot and the robot's limbs. It is most undesirable for a human-like robot in an environment with humans and interacting therewith, if the human cannot actively interact with the human-like robot and in particular physically interact with the limbs thereof.

Current robot design, and in particular the field of designing human-like robots, originated primarily from the industrial robot environment. As mentioned above, industrial robots do not need to regularly take care of their environment, nor do they need to adapt quickly or be able to physically interact with humans. Additionally, it is part of the field in human-like robot design that the robots have a similar form and size to a human being. In this sense, the physical size of a human-like robot is desirably similar to that of a human being, wherein this brings significant restrictions on the mechanics and driving system of the robot.

It is clear that in order to move the robot, and in particular the limbs thereof, some sort of drive mechanism is required. Most robot design is based around the use of electric motors driving appropriate drive trains in order to further drive the limbs of the robot in a manner which, as close as possible, mimics human behaviour. Furthermore, the motors are preferably provided in an appropriate size such that the resulting human-like robot has an appropriately human size and form, which of course limits the power output of these motors and consequently the amount of power available to run the robot itself. To overcome the issue of maximum motor size and limited power, it is quite common to utilise appropriate gear ratios as is well known in the field of mechanics. Providing a compact motor with a certain torque output would, in a direct drive scenario, only be able to provide a similar turning force to any part of the robot. As such, it is typical to provide such motors through high ratio driving systems such that the smaller motors are capable of moving robot limbs and carrying payloads with relative ease.

Whilst such systems function well, the use of high ratio drive trains brings significant drawbacks for the control of such a robot and the ease with which it can interact with humans in its vicinity. As discussed above, it is most undesirable for a robot arm to be driven without any feedback control, as even a relatively modest powered motor would, by means of a high gear ratio, be able to drive the limb of the robot with sufficient energy to potentially cause significant harm to a human unexpectedly within the path of the arm's movement. In order to minimise the chances of such harm to humans in the vicinity of human-like robots, the robots are provided with a plethora of sensors which can respond quickly to interaction with unexpected items during movement of the robot, and lead the system to take appropriate action. One could imagine a series of touch sensors or pressure sensors on the arm of a human-like robot, wherein if any of the sensors were to register positive pressure during movement of the robot arm, the system would anticipate that an unexpected object is in the path of the arm and this would lead to the system stopping motion in order to avoid driving the arm into a personal object and causing harm or damage. Quite obviously, however, the provision of a large number of sensors in order to properly mitigate potential damage from movement of a robot arm, leads not only to significant complexities in the system, but also adds an enormous cost to the production of human-like robots. Indeed, one of the most significant cost elements of human-like robot design, is the necessity of having many sensors to ensure that the movement of the robot arm cannot cause unexpected harm to any humans in the robot's vicinity.

Further issues also result from having very high gear ratio drive trains, wherein these lead to further difficulties in appropriately controlling a robot and allowing it to safely and realistically interact with humans. If the gear ratio in a robot for driving the robot arm is approximately 1:200, which is not an uncommon gear ratio in this field, it is very difficult, if not impossible, for a human being to actually move the robot arm if the arm is in the way or if the human wishes to interact with the robot. A gear ratio of 1:200 means that even small movements of the robot arm lead to excessive resistance from the motor itself, such that in many cases the robot arm is essentially immovable and realistic interaction between the human and a robot arm is impossible. This property of robot design is known as back-drivability, and is one of the significant challenges faced in the field of human-like robot design. In some designs, the back-driveability of the system can be mimicked by addition of springs and dampers on the robot arm; this has the significant drawback of adding complexity and cost whilst making the system very difficult to control. The ability for parts of a robot to physically respond to forces provided by humans in the vicinity, such that the human can actively influence the position of a robot and its limbs, is highly desirable but is also extremely difficult with high ratio drive trains. Concepts where pressure sensors are used to sense interaction of a person with the robot arm, and then actively move the robot arm in response to the sensed pressure applied, are extremely complex and add significantly to the cost of such human-like robots. Additionally, such systems are often slow to respond and perform, which leads to an unnatural feeling with the human—robot interaction.

Another significant drawback of robots in which high gear ratios are present, and which rely on complex series of drive elements to move the robot limbs, is in the issues of friction and backlash. In a cog-driven drive train, it is quite possible that a large number of separate elements exist between the motor driving the motion of a robot limb and the limb itself. Each of the cog interactions adds the potential of backlash in the system, wherein backlash can be defined as application of a force in a drive train leading to a non-linear motion of the driven gears. If a small gap exists between the tooth of the driving cog and the driven cog, it is clear that a small movement of the driving cog will ensue before the engagement of the two teeth and movement of the driven gear. This property is known as backlash and is highly non-linear and extremely difficult to model in a robot control environment. The problems with backlash are known, however in a cog driven drive train system, these issues are difficult to mitigate. Often it is necessary in the control of a robot to know precisely where the robot limb is in relation to the robot torso, such that appropriate movement of the robot limb and robot itself can be performed. If the control system is unsure where the exact position of the arm is at any given time, it is very difficult to perform appropriate movements to move the arm from this position to another location. Furthermore, if actually driving the part of the robot is susceptible to a number of systems comprising backlash, accurate movement of the robot to the new desired position becomes very difficult to program, as backlash is a non-linear problem which requires much computation to accommodate. Further significant difficulties result when trying to control the robot by means of “torque control”—that is, the application of a specific torque for a certain time; the resultant position and velocity of movement is unknown (or at best computationally very hard to determine) as a result of non-linearities in the system.

Even highly accurate bearings and precise cog design will lead to some friction existing in the system. Friction is best described as the need to provide a minimum force in order to initiate the movement of a part of the robot. The issues of friction and backlash combined can also lead to difficulties in being able to actively compute the location and motion of parts of the robot. Typically, there is a trade-off between backlash and friction in a system: low friction is achieved at the expense of high backlash, and vice-versa. If a motion of the motor does not lead to appropriate motion of a driven gear, by means of backlash problems, the system may begin to miscalculate the eventual position of the parts of the robot being driven. The same problem could arise for friction, wherein the system would have to account for certain minimum forces not leading to appropriate motion of the parts of the robot, such that again the system would have to carefully model the actual position of the robot element. Such a model would be highly inaccurate if relying solely on knowledge of the applied torques and force signals being entirely indicative of end position of the robot itself.

The present disclosure therefore takes a very different approach to the design of a human-like robot. Many of the problems arise from the need to use high gear ratios to actually move the parts of the robot in order to interact with the environment and humans existing therein. With such high gear ratios, it is then very difficult to physically interact with such robots, as discussed above, and further the problems with regard to the robot's movement being able to cause significant harm to humans in the vicinity must be accounted for. Most of these issues, however, disappear if one focuses on trying to design and build a so-called “direct drive” human-like robot. A direct drive system relates to a robot and control system which is able to accurately model the environment of the robot, and then drive the elements of the robot accordingly in order to achieve the desired task with the robot limb. Provision of a torque control system is also desirable in this scenario, wherein the motion and interaction of the robot could be controlled programming the robot such that certain torque is provided by the motors for a certain time, in order to lead to appropriate motion of the robot and limbs thereof. It is also desirable to have clear control of velocity and force in the control system, as this allows for a stable high-bandwidth control of contact forces between the robot arm and any items in its environment. Furthermore, the system is desirably provided with gear ratios of at most 1:5, and ideally closer to 1:3, 1:2 or the ultimate aim a gear ratio of 1:1. By having a gear ratio of 1:1 with direct transfer of torque from the motor to the robot limb, a direct and much more accurate motion of the robot can be controlled by movement of each of the motors to lead to movement of the robot limb. Furthermore, such a low gear ratio allows for a human to properly interact with the robot and limbs thereof, as the motor will not resist any motion of the limb or robot by application of force from the human. In such systems, it is quite possible for the human to much more realistically interact with the limb of a robot, wherein force applied by the human will lead to appropriate motion of the robot and limbs. As a final matter, this direct drive approach allows very much for the motor itself to sense applied forces to the robot, which can then more accurately model the environment around the robot and appropriately adapt thereto. This dramatically reduces the costs of such a robot, as the necessity of providing a complex series of sensors and control algorithms in response to each of the sensor signals can be significantly reduced.

The above issues are addressed in the present disclosure by means of a particular compact high torque motor design. This motor is able to provide extremely high torque to the drive system, thus allowing for a dramatic reduction in the gear ratios necessary to move limbs of the robot itself. Furthermore, by providing a cable driven system for transmitting the torque from the motor to the limbs of the robot, many of the issues regarding backlash and friction can be effectively removed. The use of such cable drives allows for direct connection between the motor and the robot part which is being moved, such that the robot itself is much easier to model and movement of the motor will lead to known and predictable movement of the cabling and eventual movement of the robot itself. Such an approach leads closely to the desired aim of a direct drive robot control system, as will be discussed in the following:

### SUMMARY OF THE INVENTION

The present application has been developed to address the issues discussed above. In particular, elements are provided in the independent claims with further details given in the dependent claims thereto, and as discussed generally below.

The present disclosure provides a motor, in particular a compact, lightweight and high torque motor, wherein the rotor comprises a Halbach array magnet structure in which the projected magnetic field is directed toward the rotation axis of the motor. The stator comprises a plurality of poles within the Halbach array, wherein the individual magnets making up the Halbach array have a thickness in the radial direction, with respect to the rotation axis, which is determined to be the minimum thickness required to stop demagnetisation of the magnets when the maximum current to generate peak torque output of the motor is driven through the stator at the maximum expected temperature at which the motor will be used.

Furthermore, the disclosure relates to provision of a joint of a robot limb which comprises the motor at least as discussed above.

Additionally, a limb for a robot is disclosed, wherein the limb comprises one or more of the joints discussed above.

Moreover, a limb for a robot is discussed, the limb comprising a plurality of limb sections which are rotationally attached to each other at a joint. One or more motors which are adapted to drive one or more of the limb sections are provided. One or more driving cables connected between one of more of the motors and one or more of the joints and/or limb sections are given, in such a manner that rotation of the one or more motors leads to a force being applied to the respective one or more driving cables which is transferred to the joint and/or limb section, respectively, and leads to rotation of the limb section around the joint. One or more of the joints comprises a differential which affords rotation of the limb section rotationally attached thereto around two separate axes in order to mimic the respective joint of a human limb. The driving cable extends directly from the motor to the driven joint and/or limb section without an intermediate shaft there-between.

A termination housing for a driving cable is also discussed. The driving cable comprises a hollow tube or sleeve of synthetic material such that a ball bearing may be placed within the hollow tube or sleeve of synthetic material. The termination housing comprises a narrow slot there-through, wherein one end of the narrow slot is provided with a wider section such that the hollow tube or sleeve of synthetic material can pass through the narrow slot into the wider section and the ball bearing positioned within the hollow tube or sleeve of synthetic material fits into the wider section. The ball bearing will not pass into the narrow slot thus stopping movement of the hollow tube or sleeve of synthetic material through the narrow slot in the direction away from the wider section.

A human like robot is also described which comprises a motor driving a limb each as generally discussed above.

### BRIEF DESCRIPTION OF THE FIGURES

FIG. 1A: An expanded view of a compact high torque motor according to the present disclosure

FIG. 1B: The motor according to FIG. 1A showing a series of possible sizes for many of the elements

FIG. 2A: Cross-section of a tooth in the stator

FIG. 2B: The diagram of FIG. 2A showing a possible range of dimensions

FIG. 3: A schematic diagram of a robot limb, in this case a robot arm

FIG. 4: A diagram showing torque transfer from the motor to a differential in a robot arm

FIG. 5: Examples of a termination housing for the cables in the drive system

FIG. 6: A schematic of a human-like robot

FIG. 7: A magnet array used in a Halbach magnet array for a rotor

### DETAILED DESCRIPTION

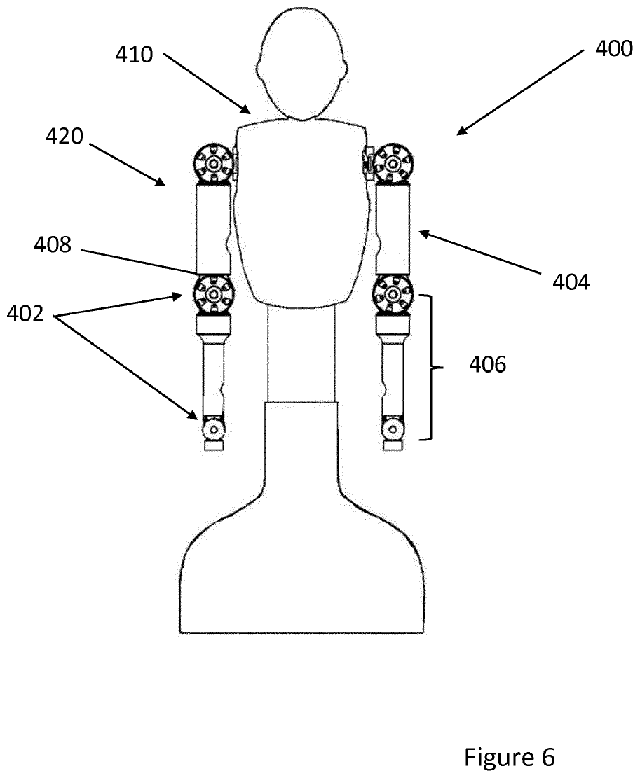

FIG. 6 shows a schematic view of a robot 400 according to the general principles of the present application. As has been discussed above, many robot designs have followed the same technological track for many years, focussing on driving movement of the robot 400 and limbs 404 thereof by means of motors driving elements of the robot 400 through increasingly high gear ratios. Indeed, it is not uncommon for gear ratios in many robot designs to have values from 1:50 and higher. In the following, a “high gear ratio” in general relates to a ratio of 1:30 and above, typically ratios of 1:50 up to 1:200 are quite common in robot limb 404 designs. Mechanical systems incorporating such high ratio gear trains allow compact motors to drive limbs 404 of robots 400, however the more complex the system, the more difficult the eventual control of the robot 400. One example of the complexities which arise from using high gear ratios, is the modelling and computer control of such systems. Many current robots 400 are provided with a multitude of position and contact sensors at various points of the robot 400, these are used in order to provide information to the control system as to both the positon of parts of the robot 400 and further whether the robot 400 or limbs 404 thereof make contact with the environment.

When designing a robot 400 which is intended to interact with changing environments, these being environments in which it is not possible to pre-program all elements into the robot beforehand and thus allow the robot 400 to constantly know its own position in relation to known objects and hazards in the environment, control is not aided by having parts of a robot 400 driven via high gear ratios. Back drivability of robot limbs 404 which are controlled by high gear ratio motor driven systems is extremely poor, as the insensitivity of the systems at the driving motor scales with the square of the gear ratio. This issue becomes particularly troublesome if a robot 400 is being designed to interact with human beings. One particular desire for such robot—human interaction is that the robot 400 can quickly adapt to a changing environment; in particular, wherein this changing environment actually includes a living person and the robot 400 must ideally adjust its motion and avoid causing potential harm to the human being in the vicinity. High gear ratios of between 1:50 and 1:200 mean that any human interacting with a limb 404 of a robot 400 will be effectively unable to influence the motion or position of the limb 404 or robot 400 in general. As movement of the limb 404 or other part of the robot 400 would need to pass through a high gear ratio back to the motor, the drivetrain effectively leads to the robot 400 and any limbs 404 thereof being immoveable: any small movement of the limb 404 or other element of the robot 400 would need to drive the motor at a high rotational velocity, meaning that the system itself provides an inherent brake or stop to movement provided by an outside source. This is particularly of concern when the robot 400 is actually driving itself or a limb 404 thereof, as of course any feedback signal as a counter force felt at the motor must also pass through the same high gear ratio leading to insensitivity. Furthermore, driving through a high gear ratio means that even a small relatively low powered motor has the strength to cause significant harm to a living person who is inadvertently in the movement path of the robot 400 or limb 404 thereof.

As discussed above, this significant issue with regard to high gear ratio robot design has led to robots 400 being provided with a plethora of sensors in order to try and avoid exactly the above issues. The use of multiple sensors at various locations of the robot 400 and limbs 404 thereof, does allow for a safety system to monitor unexpected contacts between the robot 400 and its environment, if further allows for a very quick stop in the driving of the system in order to hopefully minimise or obviate harm to objects and people in the robot's environment. The increasing number of sensors on such robots 400, however, is at increasing financial cost and complexity in both physical design of the robot 400 as well as the control system driving the same. A “human safe” robot 400 would likely need to be provided with dozens of such position and contact sensors, thus drastically increasing the cost and complexity of such a robot 400 and moving this outside of the price for many potential customers and potential uses of such a robot 400. This issue is addressed in the elements of the robot design discussed below.

Other aspects, which have also been discussed above, relate to accurate modelling and control of robots 400 operating with high gear ratios. Even the best quality gearing systems with highly accurate element interaction, suffer from issues such as backlash and friction. Backlash, for example, occurs between two cogwheels, wherein a certain movement of the driving cogwheel is necessary before the driven cogwheel starts to turn. This is either impossible to appropriately model, or is so complex a non-linear interaction that the computation required makes it impractical (if not impossible) to model. Other problems relate to simple friction between elements in a gear chain, or the like, wherein friction is another non-linear system which is again either difficult or impossible to accurately model. Both of these two problems scale non-linearly with complexity of the system, as well as with increase in gear ratio for the drive train. In light of this, whilst high gear ratios allow for sensible motor sizes to be incorporated in robot design, in particular robots which are primarily human-like and are intended for interaction with humans, the necessarily high gear ratios and complexity of the driving systems means that computer modelling is made almost impossible for direct control of the robot 400 through sensing interaction from the robot 400 or limb 404 itself, without the prohibitive provision of numerous sensors.

In order to address this issue, the current application takes a different approach to the design of a robot 400, and in particular robot limbs 404. Instead of pursuing the route of high gear ratio driving systems, with increased complexity in control and sensors, the present application proceeds from the design and implementation of a motor 100 capable of producing sufficient torque in order to be able to drive the elements of the robot 400. Previous systems generate the necessary force and power to drive elements of the robot 400 by using a compact motor through a high gear ratio. By proceeding in a different direction and providing a very high torque output from the motor 100, it is possible to dispense with high gear ratios completely and edge towards a robot 400 which is effectively “direct drive”. As will also be discussed in more detail later, additional advantages relate to positioning the motors 100 of the robot 400 as close to the robot torso 410 as possible—moving the motors 100 up the kinematic chain of the limb 404 significantly reduces the load on the system and improves operation.

“Direct drive” is a term used in the art, and primarily relates to a robotic system in which the gear ratio between the motor 100 and the driven part of the robot 400 is 1:1. This means that any movement of the motor 100 is expressed exactly in the motion of the robot 400 or limb 404. Crucially, this also means that the back drivability of the limb 404 and robot 400 in general is very high, as motion of the robot 400 or limb 404 is expressed equally largely at the motor 100. Furthermore, resistance to motion of movement of the robot 400 or limb 404 is expressed directly at the driving motor 100, meaning that the above disclosed problems of minimum feedback and potential damage to the robot environment, and crucially humans in the vicinity, are reduced if not completely obviated. Unfortunately, the term “direct drive” is often misused in the art, and is occasionally attributed to robots 400 comprising gear ratios of below approximately 1:50. In the present case, the term “direct drive” will be used to mean a system in which the maximum gear ratio is around 1:10, wherein primarily the gear ratios will be between 1:5 and 1:1.

The torque of a motor scales with the radius of the motor itself. Clearly, the simple increase in the size of an electric motor 100 will lead to an increase in the torque generated; such a torque increase would allow for the motor 100 to move larger loads, and can assist in reducing the gear ratio between the motor 100 and the robot 400 and robot limb 404. Naturally, the motors 100 within a robot 400 cannot be of any size, as increasing the size of the motor 100 has a significant impact on both the eventual size of the robot 400 itself, as well as the restriction of motion of the limbs 404 of the robot 400. Additionally, a larger motor 100 has a higher weight, and typically the weight of some of the motors 100 in the robot 400 must be lifted by other motors 100. The additional weight of a larger motor 100 to increase torque may not be of benefit overall, as this will mean an increased load which means a reduction in robot 400 performance. The general approach of the present application is to provide a robot 400 which is approximately humanoid in proportions, but which also provides limbs 404 which can closely mimic human limb behaviour. This further requirement provides a direct size limitation on the eventual motor 100, as, of course, a motor 100 cannot be designed which leads to an excessively large robot 400 or a robot limb 404 which is overly large, cumbersome and incapable of mimicking human behaviour. With this in mind, the first aspect of the present application relates to a specific design of a compact, lightweight and high torque electric motor 100.

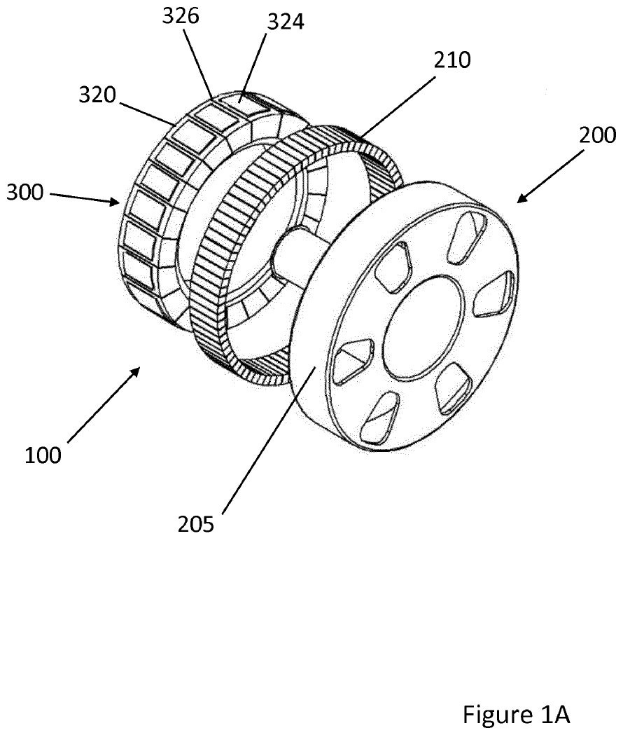

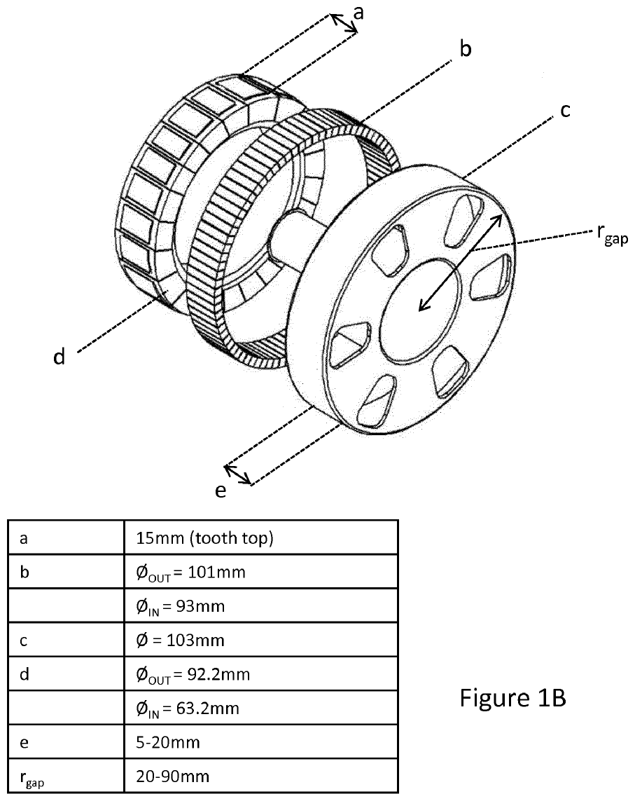

FIG. 1 shows schematically the elements of the electric motor 100 which may be used to provide sufficient torque output for driving elements of a robot 400. As will be described later, the robot 400, and in particular the joints 402 and limbs 404, may be provided with the electric motor 100 which provides sufficient torque output to allow the arm (or other joint) to be driven with a low gear ratio, typically lower than 1:10. Further important aspects are that the electric motor 100 may provide for driving of elements of the robot 400 by means of a cable drive system. The advantages of cable drive systems in robots 400 are known, however such systems are limited by the torque output from the electric motors 100 driving the same. Provision of a high torque output from a motor 100 such as that seen in FIG. 1 allows for the cable drive system to operate without resorting to gear ratios above 10:1, and will also allow a drive system approaching 5:1 or better, ideally 3:1, 2:1 or even 1:1.

As can be seen in FIG. 1, the electric motor 100 is a so-called outrider motor, wherein the rotor 200 is provided as a generally circular element which is held in a rotatable manner along the axis of rotation of the electric motor 100. The stator 300 is positioned within the rotor 200, and the stator 300 will be held stationary as the rotor 200 rotates there-around. The present electric motor 100 is generally designed to provide the most compact design for the highest torque output, and indeed the following discussion will highlight each of the design considerations which have been optimised in order to provide the highest torque output for a most compact design. As mentioned above, a high torque output for an electric motor 100 can be obtained by simply making the motor 100 larger. A large electric motor 100 is impractical in a robot 400, for simple issues of size. The present electric motor 100 represents a new design which is fully optimised for reduced size and increased output of torque, such that it can be integrated within a human-like robot 400 without requiring high gear ratios and avoiding the human-like robot from having an inappropriate size.

In order to increase the torque of an electric motor 100, the first design factor relates to the magnitude of magnetic fields which are generated at the stator 300 and rotor 200. By increasing the magnitude of the magnetic fields interacting between the stator 300 and rotor 200, the torque of the electric motor 100 can be increased. An increase in the magnetic field generated from either the rotor 200 or stator 300 can be achieved simply by making the magnet array, or electric coil respectively, configuration larger and stronger. Once again, however, this is to the detriment of the size and weight of the electric motor 100, and in particular negates such use for a human-like robot 400. In order to increase the magnetic field within the electric motor 100, the design according to FIG. 1 utilises a Halbach array of 210 of magnets. The Halbach array 210 is a known configuration of magnets, and allows for a careful tailoring of the magnetic field from each of the magnets 222 in the array, in order to both increase the amount of magnetic field and provide this in a specific direction out of the Halbach array 210 of magnets 222. The present design utilises a series of individual magnets 222 in the Halbach array 210, wherein each of the magnets 222 has its magnetic field appropriately aligned in order to fulfil the requirements of the known Halbach array 210 structure.

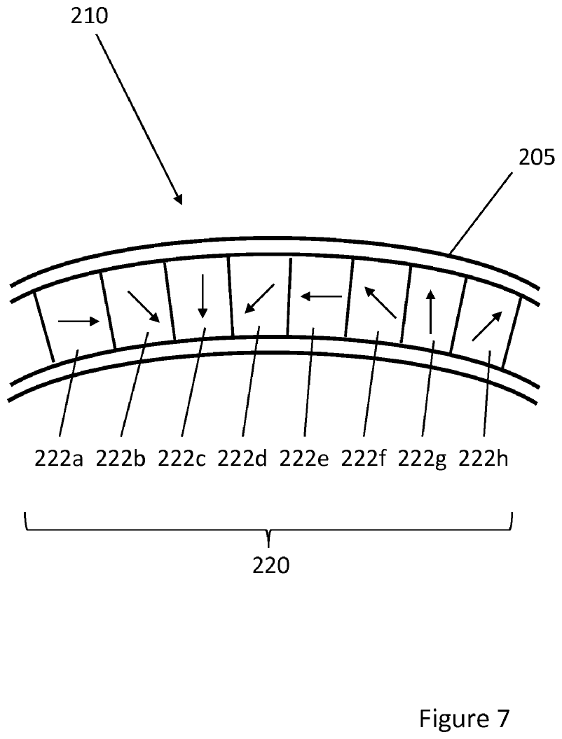

In the present case, it has been found that the output of the electric motor 100 is improved when providing a smoother magnetic field originating from the Halbach array 210. In the Halbach array 210, each Halbach array segment 220 comprises eight individual magnets 222. FIG. 7 shows the ideal orientation of the magnetic fields in each of the individual magnets 222, thus making the known magnet configuration for each Halbach array segment 220. By utilising eight individual magnets 222a-222h, as shown in FIG. 7, the resultant magnetic field is not only provided exiting the Halbach segment 222 in the downward direction as shown in FIG. 7, but also the shape of this magnetic field approaches most closely a sinusoidal configuration. Each of the individual magnets 222 is provided in the Halbach array 210 with its magnetic field oriented by 45° with respect to the adjacent magnet 222 in the array segment 220. It has been found that this provides a very close approximation to a sinusoidal magnetic field output, without requiring additional magnets 222 in the array segment 220; adding more magnets 222 increases costs and complexity, and provides only minimal improvement to the resultant shape of the magnetic field.

As can be seen from FIG. 1, the Halbach array 210 is provided as a circular array of individual magnets 222 in order to make the complete circular outer rotor 200. Such a circular array of individual magnets 222 in the Halbach array 210 allows for multiple individual Halbach array segment 220 and a number of magnetic poles, and of course pole pairs, within the resultant magnetic field. Additionally, the use of the Halbach array 210 allows for a much stronger magnetic field by weight of the rotor 200 to be provided within the centre of the rotor 200, as most of the magnetic field from the individual magnets 222 is guided through the array and into the interior of the rotor 200. This is particularly advantageous in the current motor 100 design, as of course for a given size, weight and number of magnets 222, the magnetic field resulting from the complete Halbach array 210 forming the rotor 200 will be much higher than could be achieved by means of a “normal” motor design.

In order to further improve the magnetic field strength within the rotor 200, and Halbach array 210, the Halbach array 210 is surrounded by an outer shell or band formed from a material having a high magnetic susceptibility. It is well-known in the field of magnetism that provision of an iron or steel core, or at least iron or steel elements, will allow for appropriate containment of magnetic fields, and in many cases will also lead to a significant increase in the strength of said magnetic field. In the present motor 100 the Halbach array 210 is surrounded by an outer iron or steel band 205, wherein this is utilised to appropriately constrain the magnetic field lines that extend from the outer side of the individual Halbach array segments 220 and guide these magnetic field lines back into the Halbach array 210 in order to increase the internal magnetic field. This can be seen in FIG. 7, wherein each magnet 222 of the segment 220 is bounded on the outer side, considering the radial outer side from the rotation axis of the rotor 200, by the outer band 205. This provides both mechanical stability to the Halbach array 210 and also, crucially, the constraining of the magnetic field lines back into the array 210 in order to improve the overall strength of the magnetic field.

The thickness of the outer band 205, which as highlighted above should be made from a highly magnetic susceptible material in order to appropriately guide the magnetic field back into the Halbach array 210, is expressly chosen to minimise the weight of the electric motor 100. The thickness of the outer band 205 needs only be so thick as to provide the appropriate guidance of the magnetic field back into the Halbach array 210, and further to be stable enough to physically hold the magnet 222 in the array 210 during use of the electric motor 100. Providing a thicker outer band 205 provides no additional improvement to the strength of the magnetic field within the rotor 200, adds no improvement to the stability of the rotor 200 and motor 100, and is primarily an extra weight which is unnecessary and detrimental to the use in a robot 400. One of the aims of the electric motor 100 is to reduce the weight thereof, as this of course improves the torque to weight output of said motor 100 and allows for better operation of the robot 400. To this end, one of the design considerations is the use of an outer band 205 which is only of sufficient dimensions to constrain the magnetic field, whilst also adding no additional weight over and above that necessary for physical constraint of the magnets 222 and mechanical stability.

It would also be possible to provide the outer band 205 purely for mechanical stability. If one were to choose slightly thicker magnets 222 making up the Halbach array 210, the magnetic field resulting from the array 210 would be increased, and further the stray magnetic field on the outside of the Halbach array would be less detrimental to the final operation of the motor 100. For example, the outer ring 205 could be made of a carbon composite material, as this would significantly reduce the weight of the motor 100; this combination would then likely lead to a similar or better torque to weight ratio for the motor 100, even though the outer ring 205 would not be providing any magnetic guidance of the stray fields outside the array 210. A choice of iron or steel for the outer band 205 is, however, of benefit as it is much simpler to manufacture the outer band 205 from such materials rather than using a carbon composite material. The option does of course exist for such a structure, wherein the reduction of magnetic field is accepted as the weight of the motor 100 would be lighter.

A further design constraint of the motor 100 is the thickness of the individual magnets 222 in the radial direction from the axis of rotation. As is well known, application of a counter magnetic field, as will be generated of course from the stator 300, will under certain circumstances negatively impact the magnetisation of a magnet. If a very large counter magnetic field is applied across a magnet, the actual magnetisation of the magnet may be permanently damaged leading to a reduction in the overall magnetic field strength of said magnet. These demagnetisation effects are highly temperature and magnetic material specific, but should be taken into account when considering an electric motor 100 which is to provide high torque for an appropriate size and weight. It is further of note that magnetic materials with a higher magnetic field are well known, however these tend to have lower resistance to demagnetisation at a given temperature. To this end, a selection of magnetic material is made on the basis of the expected temperature range of the electric motor 100, in order to ensure the highest magnetic field can be generated without concerns of demagnetisation of the individual magnets 222 in the Halbach array 210 through use of the motor 100.

When designing the motor 100, elements of the stator 300 will be known, and in particular the maximum magnetic field which will be generated therefrom to produce the highest torque from the motor 100. In consideration of the maximum expected magnetic field from the stator 300, the radial thickness of the magnets 222 making up the Halbach array 210 can be appropriately tailored. Once again, it is desired to minimise the weight and size of the electric motor 100, whilst leading to a higher (or the highest, per weight) magnetic field from the Halbach array 210. The demagnetisation properties of a magnet are given by the properties themselves of the magnets 222, the temperature at which the magnets will be operating as well as the radial thickness of each individual magnet 222. The design and choice of the radial thickness of each individual magnet 222 is made to ensure that even at maximum torque output of the motor 100, resulting from maximum generated magnetic field from the stator 300, the individual magnets 222 in the array will not be demagnetised, and the magnetic field from the rotor 200 will remain as desired. Again, however, excessive magnet thickness starts to give diminishing returns as this leads to increased complexity of the motor 100 and crucially increased size/diameter and weight. The thickness of the individual magnets 222 in the radial direction is, therefore, a trade-off between the eventual extra weight added for increased magnetic field, as well as ensuring that the thickness of the magnets 222 is sufficient to allow for maximum torque output without demagnetisation of the magnetic material.

The motor 100 will be used within a defined and known temperature environment, and typically will not be used at excessive heat. The choice of magnetic material is governed more for the high magnetic field which can be generated therefrom, rather than high temperature resilience to demagnetisation. The motor 100 will rarely be used in situations involving excessive driving, nor will the motor generate extreme levels of heat as a result of a large number of rotations for movement of the robot 400. To this end, the maximum temperature expected for use with the motor 100 allows for magnetic materials with higher magnetic field to be used, even though these have lower temperature resistance to demagnetisation. That is, the motor 100 is expressly chosen to have a narrow, or at least narrower, temperature usage range, as the magnets are selected from those materials which are not so resilient to higher temperature effects. In other situations, this reduced temperature range could be a major disadvantage, however the particular design for the robot 400 and the usage of the motor 100 allows for such (previously understood as) detrimental design choice.

The eventual size of the electric motor 100 is to a degree determined by the joint 402 into which the motor 100 will be placed within the robot 400. As discussed above, it is inappropriate to have a motor 100 of an excessive size in the limb 404; this would add firstly excess weight which is undesirable as the motors 100 must then lift not only the robot limb 404, the load being carried but also the heavy motors 100. Furthermore, in order for the limb 404 to be able to operate in a human-like manner, the motor 100 must have a maximum size in order that the joint 402 is not blocked by the motor 100 itself and realistic movement can thus be achieved. In this regard, the eventual size of the motor 100 determines the size, particularly the diameter, of the rotor 200. The size of the rotor 200 will then lead to an effective maximum number of individual magnets 222 that can be reliably incorporated into the Halbach array 210. When deciding how many magnetic pole pairs to include, certain features of the resultant interaction with the stator 300 may be taken into account to ensure desirable end functioning of the motor 100.

Desirably, the number of pole pairs within the Halbach array 210 is chosen to be a prime number. One the major reasons for making such a selection is that this aids in full design of the motor 100 to reduce the cogging torque of the motor 100 in use. As is known, the magnetic field from the Halbach array 210 will interact with the magnetic field generated by the stator 300, and if a large number of symmetries exist between the magnetic field from the Halbach array 210 and that generated by the stator 300, the two magnetic fields will overlap more frequently per complete rotation. The present design of motor 100 deliberately chooses a prime number for the pole pairs in the Halbach array 210 as this will allow for readily reducing the cogging torque, when designing the number of poles in the stator 300. As the number of pole pairs is a prime number, this dramatically reduces the possible number of common factors between the poles in the Halbach array 210 and that which will be generated from the stator 300. Furthermore, as discussed above, the provision of the mere sinusoidal magnetic field from the eight individual magnets 222 per Halbach segment 220 allows for a reduction in the reluctance torque ripple, which is a result of the overlap in magnetic field shape between the Halbach array 210 and that coming from the stator 300.

In particular, designs for the motors 100 are expected to have eleven, thirteen or seventeen pole pairs within the Halbach array 210. The advantages of these numbers are firstly that they are prime numbers and bring the above improvements to the operation of the motor, secondly this means that the size of the individual magnets 222 in the circumferential direction will be reasonable for manufacturing tolerances, but the Halbach array 210 will be of an appropriate size for the motor 100 to appropriately fit in the joint 402 of the robot 400. The advantage in reducing the cogging torque is significant, as the actual physical rotation speed of the motor 100 in the robot 400 of this disclosure will be quite low in use. Given that the entire robot 400 will have a low gear ratio associated therewith, the issues of cogging torque become particularly pronounced. Cogging torque for high rotation motors is of lower significance, as the motor will be rotating so quickly that the individual overlaps between the two magnetic fields to give the cogging torque will effectively be masked. In the present case, however, with such a low gear ratio the movement of the limb 404 of the robot 400 will lead to a rather slow rotation of the motor 100, and therefore issues of cogging torque could be quite pronounced—which will of course be significantly exacerbated by using such a high combination of magnetic fields. The use, therefore, of a prime number of pole pairs in the Halbach array 210 is particularly useful, as it will allow for a motor 100 with very low cogging torque.

The use, however, of a prime number of pole pairs within the Halbach array 210 of course leads to an unbalanced magnetic pull within the Halbach array 210. Ordinarily, when designing an electric motor 100 an unbalanced magnetic pole within the magnetic field would be undesirable, as this would lead to the elements vibrating significantly with rotation. In the present case, however, the speed of rotation of the elements in the motor 100 is very low and consequently the unbalanced magnetic pull has a much-reduced effect on the rotation. Indeed, the choice of the prime number of pole pairs is made to reduce the effects of cogging torque and improve the smooth rotation of the elements in the motor 100, and the negative effects regarding the unbalanced magnetic pull can be tolerated as a result of the low rotation speed of the motor element. If the rotor 200 were intended to rotate much more quickly, such an unbalanced magnetic pull would have significant detriment to the motor design, as it stands the problems associated with the unbalanced magnetic pull as a result of the prime number of pole pairs in the Halbach array 210 is offset by the improvements in cogging torque.

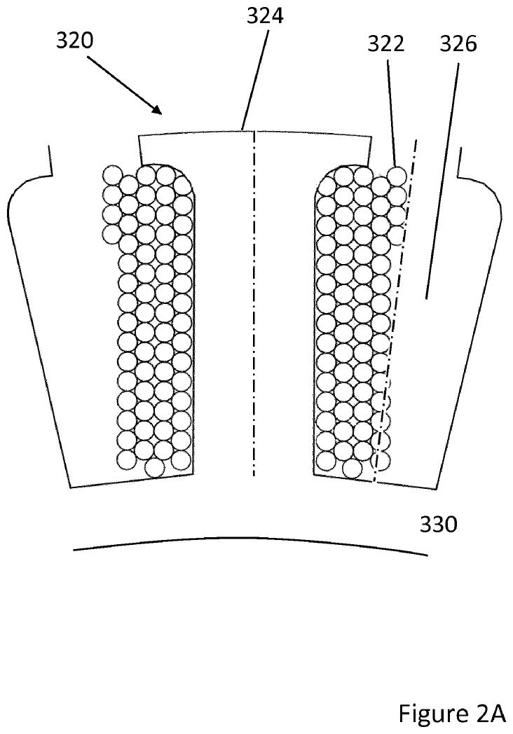

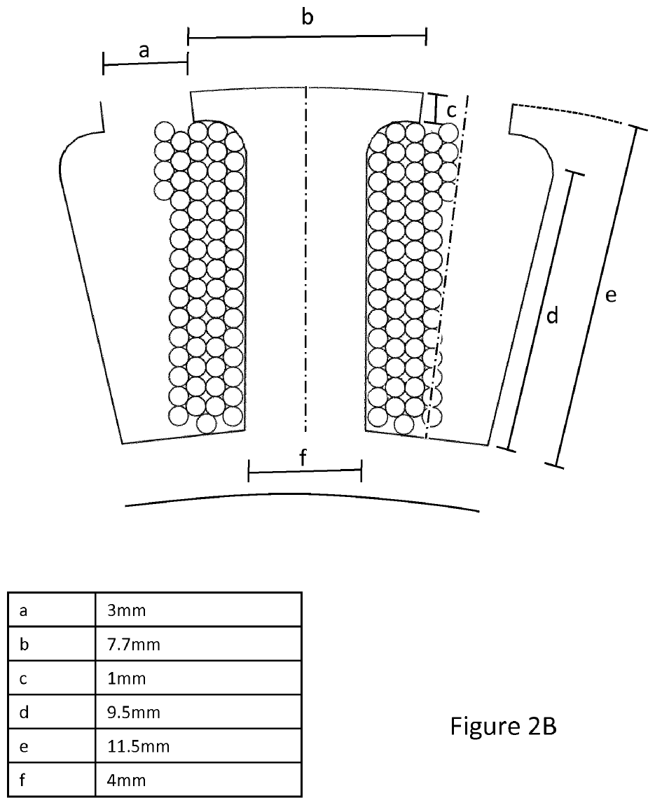

Turning attention to FIG. 2, elements relating to the stator 300 as can be seen in FIG. 1 are shown, the stator 300 is comprised of a number of poles 320 which are arranged in a circular fashion and which fit within the Halbach array 210. As with the design of the Halbach array 210, the design of the stator 300 has been optimized to improve the torque output of the motor 100 whilst also ensuring that minimum additional weight is added so as to improve further the torque to weight ratio of the motor 100. Once again, reducing the weight of the stator 300 brings the entire weight of the motor 100 down, such that the motor can be appropriately used within the eventual robot 400.

One of the first choices which can be made in designing the stator 300, relates to the actual number of individual poles 320. As highlighted above, reduction in cogging torque is particularly advantageous in the present motor 100, as this leads to the smooth operation whilst rotating, as the rotation speed of the motor 100 is intended to be quite low. In order to improve the cogging torque in combination with the above disclosed Halbach array 210, the number of poles of the stator 320 is chosen to minimise the overlap. In particular, the number of stator poles 320 should be chosen in consideration of minimising the cogging torque whilst also ensuring the use of a high, in particular the highest possible, winding factor between the stator 300 and the rotor 200. The calculation associated with generating a winding factor is generally known, and can be used to further pick an appropriate number of stator poles 320 for the eventual stator 300. One particular combination which is particularly effective in motor design, is a combination of thirteen pole pairs in the Halbach array 210 with twenty-seven stator poles 320. This combination leads to a high winding factor, whilst also giving a very low cogging torque as there are no common factors between the two sets of poles.

In FIG. 2, one sees the general design of one stator pole 320 in the stator 300. As can be seen, the stator pole 320 is designed primarily as a coil winding 322 positioned around a central T-shaped core. As is known, the magnetic field generated from a coil 322 will be significantly enhanced by providing a core of a magnetic material. In this case, it is common to use an iron or steel core, as this will lead to a significant increase in the resultant magnetic field generated when a current is passed through the coil 322. The coil 322 is shown in FIG. 2 as comprising a coil winding of wire around the central tooth or stator pole 320, other “coil” designs are also possible, and the wire solution is a non-limiting example of the same. The number of windings shown in FIG. 2 is schematic only, and in fact the number of terms of the wire around the core 320 can be any appropriate number for generating a desired magnetic field of appropriate magnitude. As is known, the larger the cross-section of coil material between the teeth, the greater the resultant torque from the motor 100—assuming no saturation of the tooth. As such, the number of coil windings (with regard to a chosen wire diameter), or more accurately the cross section of coil material, as well as the physical geometry of the T-shaped tooth is chosen to balance the eventual weight of the stator 300 with the appropriate resultant magnetic field to provide a high torque and ultimately an appropriate torque to weight ratio for the motor 100, in particular one which is appropriate for use in the robot 400. The challenge, as it were, is to appropriately balance the tooth thickness and geometry to avoid saturation at maximum current flow through the coil material, whilst providing the maximum amount of coil material to provide the maximum torque. One particular example is that the diameter of the wire in the coil 322 could lie between 0.4 mm and 0.8 mm, preferably 0.6 mm. Furthermore, the number of turns around the tooth could lie anywhere between 40 and 55, preferably 43 to 52, more preferably 45 to 50, more preferably 48 to 50.

It is undesirable to have air gaps lying between the turns of the coil winding 322, and thus the coil 322 is wound following an orthocyclic winding pattern. This tends to minimise the number of air gaps between the wires in the coil 322, and provides a dense uniform coil which provides a reliable magnetic field from the stator 300. It is also possible to press the coil windings 322 in a known manner in order to further increase the density of the coil windings 322 around the tooth and stator core 312, however in most cases in this design such extra effort does not bring around a significant improvement in the resultant magnetic field generation and torque production of the motor 100. Only at the points where the magnetic field generated from the Halbach array 210 and the coil windings 322 of the stator 300 overlap, will any magnetic field interaction lead to torque generation. In general, the axial width of the Halbach array 210 will be chosen to match the axial width of the upper surface or pole face 324 of the individual teeth on the stator 300. To this end, only the sections of the coil winding 322 which lie in the stator 300 and are overlapping in the radial direction with the magnets in the Halbach array 210 lead to an increased torque; as such, a high-density coil around the edges of the teeth in the axial direction does not bring around any significant improvement in the resultant torque. It would of course be possible to make the Halbach array 210 wider in the axial direction in order to also provide overlap with the coil windings 322 in the stator 300, however once again the improvement in magnetic field coupling and torque production is not significant when considering the significant additional weight which would arise from the larger magnets 222. To this end, the winding around the axial ends of the T-shaped teeth need not be so dense as they do not provide any interaction and magnetic field coupling.

As is known in the art, the stator core 312 is made up of laminated sheets of material with a high magnetic effect, in particular steel or iron is chosen. By laminating the core, eddy effects induced within the core material can be reduced, as is known in the art. It is further conceived that the full stator 300 will be made from a stator central ring 330, which is provided with a series of lugs or channels around the outer circumference thereof, in order to allow for the teeth of the stator poles 320 to be provided with the mating structure such that the teeth can be separately fabricated and wound prior to integration with the stator ring 330. This dramatically improves the manufacture of the stator 300, whilst also further improving the even winding of the coil windings 322.

The size, volume, geometry and shape of the individual teeth making up each stator pole 320 is particularly tailored to ensure minimum weight of the stator 300, whilst ensuring maximum magnetic field production from each coil winding 322. As discussed above, the use of a tooth within the stator pole 320 leads to a considerable magnification of the magnetic field in the known manner. As is also known, however, the magnification of the magnetic field only works up until the saturation of the material making up the stator core 320. The moment saturation of the stator core 320 occurs, the magnification effect is destroyed, and the section of tooth making up the stator core 320 no longer contributes to improving the magnetic field. To this end, it is clear that a large core to the stator coil 322 will lead to a significant improvement in the magnetic field generation, and for the maximum current passing through the coil 322 will not saturate. Of course, this increased volume of core material leads to an increase in weight of the stator 300, which is ultimately detrimental to the output of the motor 100 as the torque to weight ratio will be dramatically affected. To this end, it is desirable to tailor the size of each stator pole 320 in order to provide the best magnification to the magnetic field from the coil winding 322, without risking saturation at maximum torque output of the motor 100 and whilst also ensuring that no additional core material is present which would lead to an undesirable increase in the weight of the stator 300. Additionally, one always aims to completely fill the gaps 326 between the teeth in the stator pole 320, otherwise there is wasted capacity in the motor 100. The teeth are also designed such that saturation is avoided but that the cross section of coil winding 322, usually copper but of course any good conductor is appropriate, is increased in order to minimise the power loss of the system which results from Joule heating. The tooth design also ensures this combination—no saturation for minimised power loss.

FIG. 2b shows one particular series of sizes to the tooth making up the stator pole 320. This is in no way intended to be a limitation to the only possible structure, but gives one clarification as to a known particular tooth design which fits within a motor 100 comprising thirteen pole pairs and twenty-seven stator poles 320. Each element shown in the tooth of FIG. 2b can be properly chosen and tailored to ensure the maximum magnification of the magnetic field; this generally arises from an increase in the thickness of the tooth, as well as an increase in the pole face 324 of the tooth and an appropriate thickness for the horizontal upper flack element of the T-shaped design. Likewise, these numbers are also chosen to ensure that when the maximum current is passing through the wire of the coil winding 322, the tooth at no point saturates thus ensuring that the maximum magnetic field magnification always arises.

In any given motor design, the specific and final shape of the tooth making up the stator core 320 can be significantly different and individual. The crucial aspect is to ensure that for any given motor 100, the volume and shape of the tooth of the stator core 320 is the minimum to reduce the weight of the stator 300 and also, as discussed above, to increase the space for the coil winding 322, but is also of an appropriate geometry and volume in order to stop any possible saturation effects at the maximum current flow. It is this aspect which is the contribution from the specifics of the stator 300. Another aspect for appropriate design in the stator 300, is the size of the central stator ring 330. As is clear, by passing a coil around each tooth of the stator pole 320, magnetic field will exit from the pole face 324 but will also pass through the radial length of tooth and enter the stator ring 330. It is most undesirable for the magnetic field being generated to at any point leave the core material, as this once again leads to a reduction in the resultant magnetic field from the stator 300. The stator ring 330 is thus appropriately designed such that the maximum magnetic field which may be generated by the stator 300 will lead to no flux leakage from the radially central portion. The stator ring 330 is thus appropriately designed and the radial width is chosen to ensure that any possible magnetic field generation from the stator pole 320, will be contained within the stator ring 330 and no flux leakage arises.

The stator ring 330 could be made of a very thick material in order to ensure that no flux leakage occurs—this would then be at the expense of the weight of the motor 100. To improve the motor torque to weight ratio, the stator ring 330 is designed to have a maximum thickness; this thickness is that sufficient for containing the magnetic field in the radially more inner portion of the stator 300. Increasing the width of the stator ring 330 only brings extra weight and is unnecessary in the design, and thus is avoided. To this end, it is clear that the entire stator 300 is designed to provide a stator core 312 with the minimum weight but with the appropriate size and geometry to ensure that no magnetic field is lost, and that no possible saturation of the stator core 312 could arise during maximum torque production from the motor 100. It is further preferred that the actual winding pattern of the coil 322 follow a star winding pattern, as this is further known to increase the magnetic field and the torque output of the motor 100.

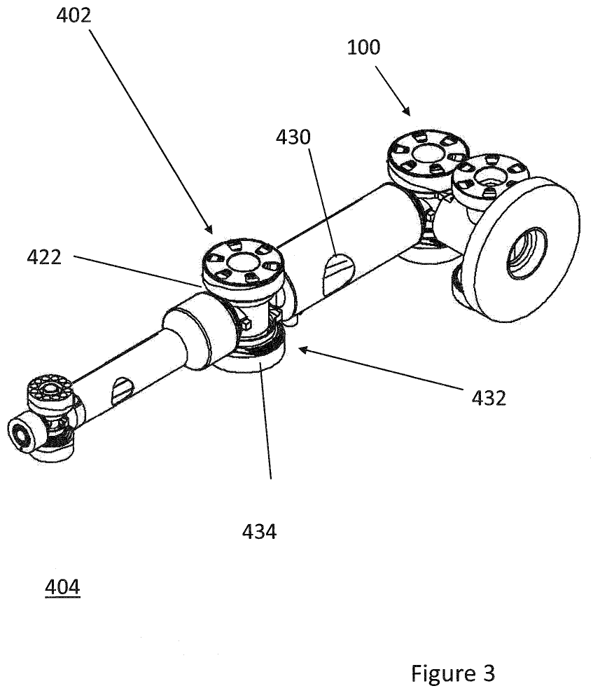

As can be seen in FIG. 3, a general design for a limb 404 of a robot 400 is provided. In FIG. 3, the limb 404 which is shown is that of the arm, however the current disclosure is not limited to production of a robot arm, rather this disclosure related to production of a limb 404 which is able to mimic human limb behaviour. To this end, the human arm is noted for providing 7 degrees of freedom in its movement, and it will be appreciated that the general design of the robot arm shown in FIG. 3 would also be capable of 7 degrees of freedom in motion. Likewise, any other limb 404 which is to be designed following the techniques herein disclosed, would provide the appropriate range of motion so as to be able to mimic human movement of the same limb 404. As will be appreciated, the limb 404 is preferably powered by a plurality of the motors 100 described above. Furthermore, the limb 404 is a cable drive system wherein the motor 100 is responsible for applying a force on each of the driving cables 430, in order to move the rotational motion of the motor 100 into appropriate motions of the joints 402 in the limb 404. The use of a cable drive system for driving a limb 404 is generally known, and many of the principles can be seen in U.S. Pat. No. 5,207,114. The disclosure of this prior US patent is incorporated in its entirety into the present application, and teachings and elements from this US document are to be considered as equally included in the present disclosure as required.

It will be well understood that rotation of the axle of a motor 100 can be translated into rotation of a drive axle in a joint 402 of a limb 404, wherein the rotation of the axle will lead to the cable being wound around the axle and thus a longitudinal pull will be made on the cable 430 as the cable is wound around said axle. The appropriate motion of the cable winding around the driving axle will, of course, lead to a cable which is appropriately wrapped around a drive axle in a joint 402 to unwind from the drive axle, wherein the unwinding will automatically lead to rotation of the drive axle. In this manner, it will be clear that rotation of the motor 100 drives the appropriate axle and can be used to provide a rotation of the driven axle. In order to allow rotation in both directions of the driven axle, it will be appreciated that two driving cables 430 are required to pass from the driving axle to the driven axle. If the first of the cables 430 is wrapped in a clockwise direction around the driving axle, when looking along the central rotation axis of the driving axle in one direction, the second cable should be provided with the opposite winding pattern, i.e. that of anticlockwise. In such a way it will be appreciated that driving the motor 100 will lead to the axle rotating and in one case the driving cable 430 will be more tightly wound onto the driving axle, thus pulling the driving cable with respect to the driven axle. Likewise, the other winding of the second driving cable 430 will generally lead to the driving cable 430 unwinding from the driving axle. This situation is reversed when the driving axle rotates in the other direction.

In order to ensure that the driven axle can rotate in both directions, the other end of each of the driving cables 430 is wrapped around the driven axle, wherein each of the rotations around the driven axle is in the clockwise direction for one cable, and the anticlockwise direction for the other cable—in a similar manner as that described above for the driving axle. As will thus be appreciated, when the first cable is pulled with respect to the driven axle, by winding the cable 430 around the driving axle from rotation of the motor 100, the cable 430 will unwind from the driven axle whilst also leading to rotation of the driven axle. In the same manner, the second cable 430 will be pulled and wound further onto the driven axle as the other end of the second cable 430 is pulled off the driving axle by rotation of the motor 100. In this way, the rotation of the driving axle leads to either a winding or unwinding of the relevant driving cable 430, wherein the unwinding of one cable will be wound onto the driven axle as the driven axle is rotated by applying tension to the other of the driving cables 430. This technique is as described in U.S. Pat. No. 5,207,114.

If one requires a joint 402 to both tilt and twist, as is effectively provided by the human elbow, it is necessary to provide a differential 432. The use of a differential 432 is also well known and is clearly defined in U.S. Pat. No. 5,207,114. The principle is that two electric motors 100 are provided, and the differential 432 is effectively a split driven axle. Each electric motor drives one of the side-drums 434 making up the differential 432, and in the same way as above will be provided with two driving cables 430 which will allow for rotation of the side-drum 434 in each direction. By providing two separate side-drums 434 in the differential 432, wherein the side-drums 434 are then appropriately attached to the limb portion or section 406 which is to be moved, it is possible to impart a tilting motion at the relevant joint 402 to move the limb section 406 out of the longitudinal axis of the limb 404. It is also possible to provide a twisting or rotating motion of the limb section 406 around the longitudinal axis of the limb 404. By appropriately driving the side-drums 434 of the differential 432, either the tilting motion or the twisting motion of the driven limb portion 406 can be achieved.

In order to cause bending at the joint 402 being driven by the differential 432, each of the side-drums 434 must be rotated in the same direction. Rotating the side-drums 434 of the differential 432 in the same direction will lead to a bending at the joint 402, and the limb section 406 will be bent out of the longitudinal axis of the limb 404. By contrast, if only one of the side-drums 434 is rotated, or more desirably each of the side-drums 434 is rotated in the opposite direction with respect to each other, the limb portion 406 is not caused to move out of the longitudinal axis of the limb 404, rather the limb portion 406 will rotate or twist around the central longitudinal axis. This system allows for a cable driven limb 404 to mimic the human arm and further to provide the range of motion given by the human arm at the elbow. As is known, the forearm can be bent out of the longitudinal axis of the arm, which is the motion achieved by rotating both side-drums 434 in the same direction and by the same amount. It is further possible to twist the lower arm, which also twists the hand, around the longitudinal axis of the arm from the elbow, wherein this motion would be used when using the hand to perform a screwing action or turning a tap on and off, for example. In this manner, the side-drums 434 and the differential 432 would be driven in opposite directions with respect to each other, which will lead to the twist of the lower limb portion 406. Once again, reference is made to U.S. Pat. No. 5,207,114 which provides details of this system.

The present case differs from this US document in a number of key aspects, the first of which being that the gear ratio between the motors 100 and the driven axles or differentials is close to, or desirably, 1:1. The ability to achieve this is advantageously by means of the motor 100 described above, as this motor provides enough torque output to appropriately drive the differential 432 or the driven axle to provide rotation of the limb 404. By having such a high torque output from the motor, wherein the peak torque from a motor as described above can be as high as 25 Nm, the limb 404 can be appropriately operated. Another key aspect of the present case, is that the driving cable 430 passes from the relevant motor 100 to either the side-drum 434 of the differential 432, or the appropriate driven axle, without provision of an intermediate shaft there-between. The advantages of providing the direct connection between the motor 100 and the side-drum 434 or driven axle is significant, and relates to the improved robot limb 404 herein described. In particular, the system obviously has a reduced complexity and comprises significantly fewer parts, which improves manufacture as well as avoiding axis mismatches between the elements of the robot limb 404.

It will also be appreciated that the driving cables 430 must be held under significant tension to ensure that relevant motion of each of the driving cables 430 directly and appropriately moves the side-drum 434 or driven axle. By minimising the number of stages between the motor 100 and driven point of the robot 400, the tensioning is direct and the number of connections and terminations of the driving cable 430 can be minimised. Furthermore, each interaction between the driving cable 430 and either the side-drum 434 or the driven axle introduces friction in the system, and thus by reducing the number of stages between the motor 100 and the driven joint 402, the friction of the entire robot is reduced. Furthermore, if a direct connection is provided between the motor 100 and the joint being driven, an increase in the transparency of the limb 404 occurs, as direct motion of the limb 404 at the joint 402 will be transposed via the driving cable 430 to the motor 100. Another advantage of this system relates to the provision of driving cables 430 which are shorter, which has the significant advantage that the elongation of such cables is reduced. The driving cables 430 have a tolerance in their extension under tension, and the shorter the cable the shorter the actual elongation during use, which leads to obvious improvements in the system. Finally, a crucial and important point in this system, is that the reduction in the number of parts within the joints 402 allows for the joint 402 to be smaller and a higher range of motion is possible as there are fewer parts to physically block the bending and rotation of the limb sections 406.

In the design for the limb 404, the positioning of each of the motors 100 is critical. Importantly, every motion which is made by the limb 404 is subject to gravity.

Furthermore, each motion of the limb 404 must move a particular mass of material, wherein inertia and the force of gravity of the simple mass must also be overcome in order to provide appropriate movement at the joint 402 of the limb 404 and limb section 406. In order to minimise or even remove the effects of gravity for motion of the limb 404, the positioning of the motors 100 is performed in a symmetric manner around the longitudinal axis of the limb 404. As can be seen in FIG. 3, the upper top right of the arm acts as the shoulder joint, and as can further be appreciated each motor 100 is provided in a symmetric location either side of the longitudinal axis along the limb 404. Of course, raising and lowering of the limb 404 requires that the limb sections 406 and the joint 402, which in this case would be the elbow joint, must be lifted, and at this point the effects of gravity cannot fully be avoided. Gravity will act on the arm as expected, and therefore the arm will generally be pulled downward. It will be appreciated, however, that when the motors 100 which are provided symmetrically either side of the longitudinal axis of the limb 404 are so positioned, the rotation of the limb 404 and limb sections 406 around the longitudinal axis of the limb 404 will offset each other with respect to gravity. If the arm is being held at any position other than vertically downward, it is clear that rotation of the limb 404 around its longitudinal axis will lead to one of the motors 100 moving upward with respect to the ground, whereas the other motor will move by a corresponding amount downward toward the ground. These two motions of the motors 100 counter each other, and the effects of gravity on such rotation is cancelled out. To this end, it is most desirable to provide the motors at symmetric positions either side of the rotational longitudinal axis of the limb 404.

One other feature of the limb 404 is that the motor 100 driving the joint 402, and in particular the motors 100 driving the differential 432, are located at a position in the limb 404 which is physically removed from the joint 402 being driven. In FIG. 3, the two motors 100 provided at the upper right of the image are actually being used via driving cables 430 to drive the elbow joint which is positioned in the middle of the limb 404. The elbow joint is shown in the figure as 408. Likewise, in FIG. 3 two motors 100 are provided at the elbow joint 408 and are being used to drive the wrist 409. This is not intended to be a limitation, as indeed the motors 100 driving the wrist 409 could readily be provided at the upper part of the limb 404, at what would be the shoulder for an arm. Provision of the motors 100 driving the joints 402 further down the limb 404, at the closest point at which the limb 404 will be attached to the torso 410 of the robot 400, brings significant improvements to the operation of the limb 404. One of the main issues in robot limb 404 movement is the constant pull of gravity on the limb. If elements being used to drive the limb 404 are positioned on the limb 404 itself, and in particular further away from the point of fixation to the robot torso 410, each motion of the arm must also lead to movement of the motors. As the motors are possessed of mass, this means that more torque is required to lift the limb 404, which means that the eventual lift which the limb 404 can achieve will be reduced. By positioning the motors 100 as close to the robot torso 410 as possible, and ideally having all motors 100 at a fixed point attached to the robot torso 410, the limb 404 will have a dramatically reduced weight; this will therefore mean that the torque from the motors 100 either allows for a significantly improved maximum lift with the limb 404, or means that the motors themselves 100 can be designed to be smaller because the maximum torque required from the motors 100 is lower as the limb 404 is lighter.

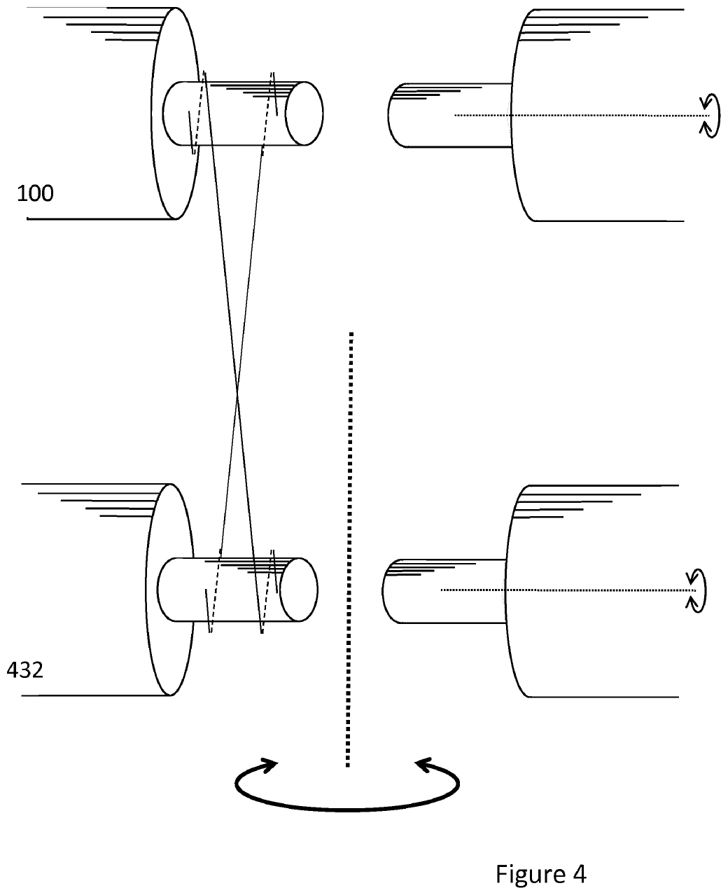

As has been discussed above, reduction in the size of the motors 100 leads to much smaller joints 402 which allows for said joints 402 to mimic human behaviour, thus allowing for a human-like limb 404 to be constructed. Indeed, it is anticipated that by means of the cable drive system, and in particular the torque transfer drive system to be discussed in relation to FIG. 4, it will be possible to position all motors 100 at the point of the limb 404 which is physically attached to the torso 410 of the robot 400. Such positioning will thus mean that the only elements which need to be moved are the differentials in the limb 404 and the limb sections 406. It will be appreciated that this will lead to a significant improvement in the mass of material which must be moved, which will itself lead to a great improvement in either the maximum lift or necessary size of motors 100.

FIG. 4 shows a solution to the issues of transporting torque from a motor 100 which is positioned in a joint 402 of a limb 404 translationally separated from the joint which the motor 100 is driving. As has been discussed above, one particular improvement which can be envisaged in the present disclosure, is the positioning of motors 100 close to the torso 410 of the robot 400. Positioning the driving motors 100 in regions close to the torso 410 reduces effects of gravity when moving the limb 404. It is also of advantage to position the motors 100 in a previous joint 402 of the limb 404, as this allows for both a compact design as well as a ready mechanism for allowing the symmetric positioning of the motors 100. The robot limb 404 will be possessed of joints 402, wherein the joints 402 will provide the ideal location for stably housing the motors 100. Of course, positioning the motors 100 in a joint 402 is not a limiting option, and the motors 100 may also be located simply at a position on the limb 404 closer to the robot torso 410. Even in these situations, it is necessary to be able to appropriately transmit the torque from the motors to the joint in question, to give appropriate movement of the joint 402.

In FIG. 4, a wiring design for the driving cables 430 is provided which allows for torque to be transmitted from the motor 100 through to a differential 432, wherein the motor 100 is not intended to move with the differential 432. As will be appreciated from the limb 404 shown in FIG. 3, the motor 100 provided in what would appear to be the shoulder in the limb 404 is driving the joint at the elbow 408. If the limb 404 is controlled such that the elbow 408 twists around the longitudinal axis of the limb 404, it is clear that the axles in the differential 432 will twist with respect to the axles of the driving motors 100. It will further be clear that the positioning of the driving cables 430 in this system will not lie along the rotational axis of the limb 404, such that twisting of the differential 432, in this case at the elbow 404, would lead to an extension or unexpected change in the length of the cable running between the motor 100 and the differential 432. Furthermore, it would be possible for the driving cables 430 to experience unwanted extra tension or reduction in tension leading to poor control over the twisted differential 432. The wiring design in FIG. 4 allows for the point of rotation at the differential 432 to be slightly offset from the longitudinal axis of rotation at the elbow 408, and accommodates this change in rotational alignment between the axle at the motor 100 and at the differential 432. In the same manner as described above for driving axles from a motor 100, two driving cables 430 are envisaged, wherein these driving cables extend between the motor 100 and differential 432 as indicated in FIG. 4.

In particular, the first driving cable 430 extends from the motor 100 to the differential 432 in a slightly offset from axial path between the motor 100 and differential 432. The limb 404 is provided with a longitudinal axis through the middle, wherein the differential 432 will generally rotate around this central axis when a twist is introduced, such as could be understood from FIG. 3 as a twist of the lower arm at the elbow 408. The first cable 430 passes from the motor 100 to the differential 432 from a position slightly radially away from the central axis of the rotation of the limb 404 at the motor 100, to a position closer to the rotation axis of the limb 404 at the axle on the differential 432. The second driving cable 430 is located in essentially the opposite geometry, moving from a point on the motor 100 axle closer to the rotation point of the limb 404, to a location on the differential 432 axle slightly further away from the rotation point of the limb 404. This will lead in a plan view to a generally crossed series of driving cables 430, as can be seen in FIG. 4.

Another crucial point to the wiring design as shown in FIG. 4 for the driving cables 430, is that the winding of each cable 430 around the respective axle at the motor 100 or differential 432 means that the cable 430 stays either at the front side of the two axles or the rear side of the two axles as viewed in FIG. 4. That is, the respective driving cables 430 do not crossover when viewed along the axial direction of the axle at the motor 100. The first cable, as shown on the left hand side from the motor 100 to the right hand side at the differential 432, is shown passing around each axle such that it extends from the front side of the axle at the motor 100 to the front side of the axle at the differential 432, and is appropriately wound around each axle such that rotation at the motor 100 leads to rotation of the differential 432. The second cable 430 passes around each axle such that the cable 430 extends from the rear side of the motor axle to the rear side of the axle at the differential 432. That is, the cables are either side of each axle of the motor 100 and differential 432.

By wiring each connection between the motor 100 and differential 432 in the above manner, the rotation of the differential 432 around the rotation axis as shown in FIG. 4 will lead to effectively the same change in length between the two fixation points of each cable 430 at the motor 100 and differential 432. The point in which the cable 430 leaves the axle at the motor 100 is, to a first order, fixed, as the motor 100 will not rotate or move with respect to the robot torso 410, rather it is the differential 432 which moves with respect to the motor 100. To this end, the positioning of the cable 430 at the motor axle can be considered as fixed, wherein the position of the cable 430 at the differential 432 can be considered as moving along a circular path such a cone outer surface is partly described as the differential 432 twists with respect to the motor 100. The second cable 430 will operate in the same manner as the first cable 430, wherein the twist of the differential 432 will also lead to a path similar to that of a section of a cone being described. In this way, the twist of the differential 432 with respect to the motor 100 has a similar effect on each cable 430, and each cable will be affected in the same manner leading to an appropriate and slight increase in the tension in each cable; the effects of the rotation at the differential 432 on each cable 430 will, however, generally cancel out and no unexpected motion or twisting at the differential 432 will arise. This wiring pattern allows explicitly for the torque at the motor 100 to be successfully transferred to the differential 432 without any unexpected motion of the differential 432 or loss of tension in the cable 430 as a result of the relative motion at the differential 432 with respect to the axle at the motor 100.

One final crucial aspect to the current disclosure is that of the termination of the driving cables 430. It will be appreciated that the cables 430 must be kept under high tension in order to ensure that they do not unexpectedly slip or unwind from either the motor 100 or the differential 432. In order to achieve this, the present disclosure utilises a driving cable 430 solution incorporating a synthetic material, rather than the metal cabling discussed in U.S. Pat. No. 5,207,114. The advantages of using a synthetic driving cable 430 are numerous, not least the saving in weight as well as the improvements in the minimum bend radius which can be achieved with such a cable 430. Steel cable has a minimum bend radius for attachment round an axle for given diameter of wire and strength capability. In order to provide a compact robot 400, and in particular a compact joint 402 for a limb 404, it is often necessary to provide smaller axles which require a narrower diameter steel cable in order to cope with the smaller bend radius. Such steel cables, however, do not provide the appropriate strength for transmitting the high torque which can be generated from the motor 100, and thus it would be envisaged that multiple metal cables would be required between the motor 100 and the driving axle or differential 432. Using multiple metal cables for transmitting a torque signal is extremely troublesome, as the slightest length difference between one of the steel cables will lead to this cable transferring no torque and the torque being split over the remaining cables. This adds a significant level of complexity to the design and manufacture of such a robot 400. It is for at least these reasons that the present disclosure envisages using a synthetic cable for transmitting a torque between the motor 100 and differential 432.

One particular synthetic fibre which has proven to have appropriate properties, is that of a Vectran synthetic material. Vectran is a known fabric and can be found at: http://www.vectranfiber.com/. This fibre has a known structure which has proven successful in both transmission of torque between the motor 100 and differential 432, and further provides an appropriate bend radius and low friction between the cable 430 and the axles being driven. Of course, the use of Vectran is one possible example, and any driving cable 430 which is able to transmit the high torques, wherein this can be up to 25 Nm, without significant elongation and at a small radius of curvature, are equally applicable at this stage. The use of Vectran is therefore one example of such a synthetic fibre which can be used in the present case.

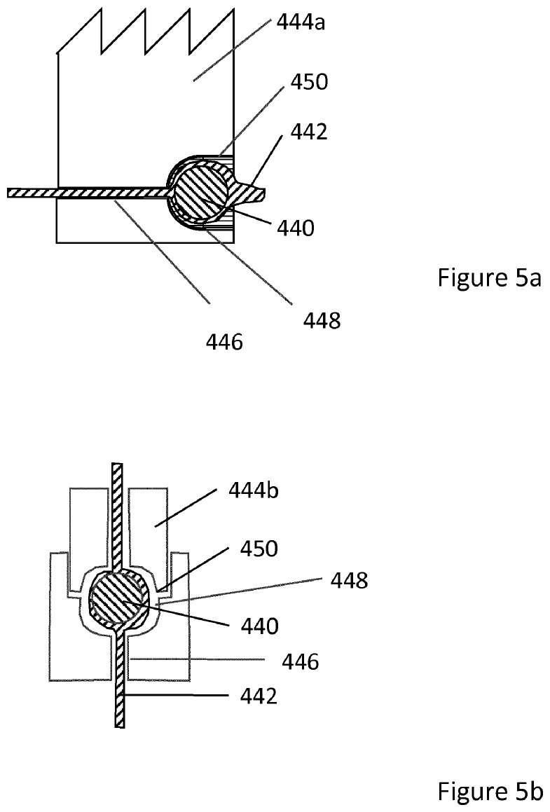

The use of a synthetic fibre also brings the advantage in that this material can be woven not only into a rope-like structure, but also into a tubular sleeve structure. Details of this tubular sleeve can be found for Vectran, at least at the above web address, and the production of synthetic fibre tubular sleeve structures is generally known in the art. The advantage of providing the present driving cables 430 from such a sleeve structure, is that a fixation at the ends of the driving cables 430 is enhanced. Two possible solutions for fixing one end of the Vectran sleeve 442 are shown in FIG. 5, wherein this solution relates to the introduction of a ball bearing 440 within the central lumen of the Vectran, or other synthetic material, sleeve 442.

Two different termination housings 444 are shown in FIG. 5, however the principle operation is similar in each case. In FIG. 5A, a unidirectional termination housing 444a is shown, wherein the driving cable 430 in the form of the sleeve 442 will be stopped from moving in the right to left direction as show in FIG. 5A. The relevant tension can be applied to the driving cable 430 and the end of the cable passes through the narrow slot 446 within the termination housing 444. Positioning a ball bearing 440 within the lumen of the synthetic sleeve 442, allows this ball bearing 440 to fit within a wider section 448 at one end of the narrow slot 446. By ensuring that the ball bearing 440 is too large to fit through the narrow slot 446, it will be appreciated that the synthetic sleeve 442 will be held in position if a tension is applied on the sleeve to try and pull this in the direction away from the wider slot 448. The movement of the synthetic sleeve 442 in the general direction left as shown in FIG. 5A, that is trying to pull the sleeve 442 through the narrow slot 446, will lead to the ball bearing 440 being pulled against the edge of the wide slot 448 meeting the narrow slot 446, and friction will ensue that resists the further withdrawal of the sleeve 442 through the narrow slot 446. In order to further ensure that the tension on the cable 430 is maintained, once the cable has been tensioned appropriately, the ball bearing 440 is positioned within the lumen and in the wide slot 448, and finally the relative position between these two can be fixed by means of an appropriate glue 450. This will then allow the cable 430 to maintain the appropriate tension whilst also stopping the cable 430 from passing out to the left through the narrow slot 446.

This same principle is applied to the termination housing 444b as shown in FIG. 5B, however in the 5B solution the position of the cable 430 is fixed in both tension directions. In this case, the termination housing 444 is made from two separate parts, each of which has a narrow slot 446 passing there-through into which the synthetic fibre sleeve 442 will be threaded. The ball bearing 440 is positioned at the relevant point within the lumen of the sleeve 442, and part of the ball bearing 440 within the sleeve 442 is held within the wide slot in one part of the termination housing 444. The second termination housing is then threaded along the other side of the synthetic tube 442 until it meets and houses the remaining part of the ball bearing 440 within a wide slot 448 formed therein. Once tensioning has been placed on the cable 430, glue 450 can again be positioned within the wide slots 448 of each part of the termination housing 444 and the position of the sleeve 442 will be maintained and the tension maintained on the cable 430. These two solutions provide an elegant way of fixing the end of tension cable 430 in order to ensure that the torque is directly transferred from the motor 100 to the relevant joint 402 and differentials 432.

1. A motor, in particular a compact, lightweight and high torque motor, wherein
the rotor comprises a Halbach array magnet structure in which the projected magnetic field is directed toward the rotation axis of the motor; and
the stator comprises a plurality of poles within the Halbach array;
wherein further
the individual magnets making up the Halbach array have a thickness in the radial direction, with respect to the rotation axis, which is determined to be the minimum thickness required to stop demagnetisation of the magnets when the maximum current to generate peak torque output of the motor is driven through the stator at the maximum expected temperature at which the motor will be used.

2. The motor according to claim 1, wherein the Halbach array is located within an outer band of high magnetic susceptibility material, preferably steel or iron, the thickness of which being chosen to be the thinnest possible whilst both:
a) completely constraining the outer magnetic field from the Halbach array; and
b) providing complete mechanical stability to the rotor.

3. The motor according to claim 1, wherein the magnets are made from a magnetic material which has a high magnetic field strength but a low temperature resistance to demagnetisation, thereby providing higher torque at the expense of reduced usable temperature range of the motor.

4. The motor according to claim 1, wherein the Halbach array comprises a prime number of pole pairs.

5. The motor according to claim 4, wherein the number of poles in the stator is different from the number of pole pairs in the Halbach array, and wherein preferably the number of poles in the stator is also a prime number and/or wherein the number of poles in the stator is not an integer multiple of the number of pole pairs in the Halbach array.

6. The motor according to claim 5, wherein the number of poles in the stator is chosen in consideration of the number of pole pairs in the Halbach array to ensure a high winding factor.

7. The motor according to claim 6, wherein the number of poles in the stator is chosen in consideration of the number of pole pairs in the Halbach array to reduce the cogging torque and/or the reluctance torque of the motor.

8. The motor according to claim 7, wherein the number of pole pairs in the Halbach array is one of 11, 13 or 17.

9. The motor according to claim 8, wherein the number of pole pairs in the Halbach array is chosen and/or determined based on the physical size of the motor.

10. The motor according to claim 9, wherein the number of individual magnets in each pole of the Halbach array is 4, meaning that each pole pair comprises 8 individual magnets and magnetic field direction in each of the individual magnets is offset by 45° with respect to the adjacent individual magnets.

11. The motor according to claim 10, wherein each pole of the stator comprises at least one tooth formed of a high magnetic susceptibility material, preferably steel or iron, which has a conductive coil wrapped around it; wherein
the size and shape of each tooth is chosen such that both:
a) magnetic saturation will not occur for the maximum applied current which is designed to be applied to the coil in use for generation of the maximum magnetic field and thus torque of the motor, and
b) the volume, size and/or mass of the tooth is as low as possible, whilst fulfilling requirement a).

12. The motor according to claim 11, wherein the stator has a stator core which comprises a plurality of laminated high magnetic susceptibility layers, preferably from iron or steel, each laminate being in the plane lying perpendicular to the axis of rotation of the motor.

13. The motor according to claim 12, wherein each tooth is formed individually and has a mechanical fixation structure which is designed to mechanically interact with a matching structure on the stator internal ring so as form the complete stator ring.

14. The motor according to claim 13, wherein the stator comprises a stator internal ring, which is an annular structure centred on the axis of rotation of the motor, the stator internal ring having a radial thickness, as determined from the axis of rotation of the motor, which is the smallest to ensure that it will be thick enough to contain and constrain the maximum magnetic field that will be generated by the stator, and that the stator internal ring is not thicker than is necessary to contain or constrain the maximum magnetic field.

15. The motor according to claim 14, wherein the conductive coil of the stator comprises one or more conductive wires which are wrapped around each tooth by means of orthocyclic winding.

16. The motor according to claim 15, wherein the one or more conductive wires are not further pressed after winding around the tooth, and that the wire is not tightly wound and/or wound with high structural order at the outer end regions of each tooth, this end region being the region of the coil which will not overlap with the Halbach array when the motor is constructed.

17. The motor according to claim 16, wherein the conductive coil comprises a conductive wire with a width between 0.4 mm and 0.8 mm, preferably 0.5 mm to 0.7 mm, more preferably 0.6 mm; and further
wherein the conductive wire is wound round the tooth between 40 and 55 times, preferably between 43 and 52 times, more preferably between 45 and 50 times, even more preferably between 47 and 50 times.

18. The motor according to claim 17, wherein the number of pole pairs in the Halbach array is 13 and the number of poles in the stator is 27.

19. The motor according to claim 18, wherein the air gap between the ends of adjacent conductive teeth in the stator core, taken in the circumferential direction of the stator core, is much greater than the air gap between the ends of the conductive teeth in the stator core and the magnets in the Halback array in the radial direction of the stator core with respect to the axis of rotation, in particular
the air gap between the teeth is 10 times, preferably 8 times, more preferably 6 times larger than the air gap between the teeth and the magnets of the Halbach array.

20. The motor according to claim 19, wherein the teeth of the stator core are generally “T” shaped, and wherein the width of the upright section which lies along the radial direction from the axis of rotation is chosen to ensure that:
a) magnetic saturation of this part of the tooth will not occur for the maximum applied current which is designed to be applied to the coil in use for generation of the maximum magnetic field and thus torque of the motor, and
b) the volume, size and/or mass of this part of the tooth is as low as possible, whilst fulfilling requirement a).

21. The motor according to claim 20, wherein the teeth of the stator core are generally “T” shaped, and wherein the width of the cross section which lies along the circumferential direction around the axis of rotation is chosen to ensure that the cross part of the “T” will lie between at least 70% of the coil and the Halbach array, preferably between 80% of the coil and the Halbach array, more preferably between 90% of the coil and the Halbach array, most preferably between 100% of the coil and the Halbach array, ignoring the curved regions of the coil not overlapping with the Halbach array.

22. The motor according to claim 21, wherein the teeth of the stator core are generally “T” shaped, and wherein the thickness of the cross section which lies along the circumferential direction around the axis of rotation is chosen to ensure that:
a) the magnetic saturation of the cross part of the “T” of the tooth will not occur for the maximum applied current which is designed to be applied to the coil in use for generation of the maximum magnetic field and thus torque of the motor, and
b) the volume, size and/or mass of the cross part of the “T” of the tooth is as low as possible, whilst fulfilling requirement a).

23. The motor according to claim 22, wherein the teeth of the stator core are generally “T” shaped, and wherein the length of the upright section which lies along the radial direction from the axis of rotation is chosen to ensure that the improvement in the maximum magnetic field from the stator is not offset by the increase in weight from the additional coil length.

24. The motor according to claim 23, wherein the winding pattern of the coil around the stator is a star winding pattern.

25. A joint of a robot limb comprising the motor of claim 24.

26. A joint of a robot limb comprising the motor claim 24, wherein the size, in particular the diameter of the motor, is chosen, and thus the number of pole pairs of the Halbach array are determined to fit appropriately therein, to ensure that the resultant size of the joint is small enough to allow for the robot limb to operate in a human-like manner.

27. A limb for a robot, wherein the limb comprises one or more of the joints according to claim 26.

28. A limb for a robot comprising:
a plurality of limb sections which are rotationally attached to each other at a joint;
one or more motors adapted to drive one or more of the limb sections; and
one or more driving cables connected between one of more of the motors and one or more of the joints and/or limb sections in such a manner that rotation of the one or more motors leads to a force being applied to the respective one or more driving cables which is transferred to the joint and/or limb section, respectively, and leads to rotation of the limb section around the joint; wherein
one or more of the joints comprises a differential which affords rotation of the limb section rotationally attached thereto around two separate axes in order to mimic the respective joint of a human limb; wherein further
the driving cable extends directly from the motor to the driven joint and/or limb section without an intermediate shaft there-between.

29. The limb according to claim 28, wherein this is a cable driven robot arm exhibiting 6, preferably 7, degrees of freedom and being operable to mimic human arm movements.

30. The limb according to claim 29, wherein the maximum gear ratio between the one or more motors and the driven joint and/or limb section is 1:10; preferably 1:8; preferably 1:6; preferably 1:5; preferably 1:4; preferably 1:3; preferably 1:2 and most preferably 1:1.

31. The limb according to claim 30, wherein each of the differentials comprises two side-drums which are held rotationally in the joint, wherein each side-drum is rotationally driven by a separate motor located at a different joint of the limb.

32. The limb according to claim 31, in particular claim 31, wherein the motors driving the side-drums are located in a joint which will be closer to the torso of the robot to which the limb will be attached than the joint in which the side-drums are located.

33. The limb according to claim 32, wherein the one or more motors driving the joint are located in a separate joint which will be closer to the torso of the robot to which the limb will be attached than the joint being driven by the one or more motors.

34. The limb according to claim 33, wherein the torque from the one or more motors is transferred to the driven joint or differential by means of driving cable winding system which is so structured that longitudinal rotation of the joint or differential around the longitudinal rotation axis of the limb and with respect to the one or more motors will not lead to rotation of the differential around the differential's axis of rotation.

35. The limb according to claim 34, wherein the driving cable winding system comprises two driving cables each extending from the driving axle of one motor to the driven axle of the joint or differential, wherein the driving cables are wound such that:
the first driving cable is wound on the driving axle of the motor at a location further removed from the longitudinal axis of rotation of the limb than the second driving cable, and
the first driving cable is wound around the driving axle of the motor in one of either a clockwise or anticlockwise manner, when viewed along the axis of rotation of the driving axle of the motor, and the second driving cable is wound around the driving axle of the motor in the other of an anticlockwise or clockwise manner; and further
the second driving cable is wound on the driven axle of the joint or differential at a location further removed from the longitudinal axis of rotation of the limb than the first driving cable, and
the first driving cable is wound around the driven axle of the joint or differential in the same clockwise or anticlockwise manner as around the driving axle of the motor, when viewed along the axis of rotation of the driven axle of the joint or differential, and the second driving cable is wound around the driven axle of the joint or differential in the same clockwise or anticlockwise manner as around the driving axle of the motor, such that the cables cross over between the motor and the joint or differential and that rotation of the joint or differential around the longitudinal rotation axis of the limb leads to the driving cables being equally tensioned leading to no unexpected rotation of the differential around the differential's axis of rotation.

36. The limb according to claim 35, wherein the one or more motors are grouped in pairs for driving the differentials and/or joints and are located symmetrically either side of the longitudinal rotation axis along the limb, so as to negate the effects of gravity on the limb during longitudinal rotation.

37. The limb according to claim 36, wherein the limb sections are hollow and the driving cables extend through the hollow portion of the limb sections.

38. The limb according to claim 37, wherein the motor.

39. A termination housing for a driving cable, wherein the driving cable comprises a hollow tube or sleeve of synthetic material such that a ball bearing may be placed within the hollow tube or sleeve of synthetic material;
the termination housing comprising a narrow slot therethrough, wherein one end of the narrow slot is provided with a wider section such that the hollow tube or sleeve of synthetic material can pass through the narrow slot into the wider section and the ball bearing positioned within the hollow tube or sleeve of synthetic material fits into the wider section but will not pass into the narrow slot thus stopping movement of the hollow tube or sleeve of synthetic material through the narrow slot in the direction away from the wider section.

40. A termination structure comprising the termination housing of claim 39, a hollow tube or sleeve of synthetic material passing through the narrow slot and wider section and a ball bearing held within the hollow tube or sleeve of synthetic material and placed within the wider section thus stopping movement of the hollow tube or sleeve of synthetic material through the narrow slot in the direction away from the wider section.

41. The termination structure according to claim 40 wherein the termination housing is a first termination housing and the wider section is so sized that it can only house part of the ball bearing the termination structure further comprising a second termination housing in which the wider section is so sized that it can house the remaining part of the ball bearing exposed by the first termination housing; wherein
the first and second termination housings are structured that they mechanically interact and form a cavity for the ball bearing thus stopping movement of the hollow tube or sleeve of synthetic material through the narrow slots in either direction.

42. The termination structure according to claim 41, wherein glue is provided to fix the ball bearing in the wider section and to hold the first and second termination housings together.

43. The limb according to 38, wherein the driving cable comprises a hollow tube or sleeve of synthetic material which is terminated by means of termination housing or structure.

44. A human like robot comprising a motor according to claim 23 driving a limb.
